(19) United States
(12) Patent Application Publication
(10) Pub. No.: US 2007/0198377 A1
(43) Pub. Date: Aug. 23, 2007

(54) Mortality and Expense Risk Charges with Premium-Based Breakpoints in Annuity Products

(75) Inventors: James L. Livingston, Centennial, CO (US); Steven M. Kluever, Highlands Ranch, CO (US); Clifford J. Jack, Cherry Hills Village, CO (US)

Correspondence Address: BANNER & WITCOFF, LTD., 1100 13th STREET, N.W., SUITE 1200, WASHINGTON, DC, 20005-4051, US

(73) Assignee: JACKSON NATIONAL LIFE INSURANCE COMPANY, Lansing, MI (US)

(21) Appl. No.: 11/463,046

(22) Filed: Aug. 8, 2006

Related U.S. Application Data
(60) Provisional application No. 60/765,495, filed on Feb. 3, 2006.

(51) Int. Cl. G06Q 40/00

(52) U.S. Cl. 705/35

(57) ABSTRACT

Annuities are provided that specify breakpoint ranges for Mortality & Expense (M&E) rates. These breakpoint ranges may be associated with a premium payment amount and/or aggregate premium payment amount. This payment amount may fall within one of the breakpoint ranges associated with a particular M&E rate, which may be considered the maximum M&E rate for the life of the annuity. However, if a committed amount was utilized in determining the M&E rate, then the maximum M&E rate may be revised if the committed amount in the statement of intention has not been met or has been exceeded. Additionally, subsequent premium payment amounts and/or aggregate payment amounts, when accumulated with the previous premium payment amounts and/or aggregate payment amounts, may fall within another breakpoint range with a lower M&E rate. This lower M&E rate may apply to either the previous premium payment amounts or only to the subsequent premium payment amounts.

### RELATED APPLICATIONS

The present application claims priority to U.S. Provisional Application Ser. No. 60/765,495, filed Feb. 3, 2006, entitled “Systems, Methods, and Computer Program Products for Annuity Products Having Breakpoints for Mortality and Expense Charges,” which is hereby incorporated by reference in its entirety.

### BACKGROUND

Variable annuities are generally contractual relationships between parties and an insurance company, where the insurance company agrees to make periodic payments to the parties and/or their beneficiaries, beginning either immediately or at a future date. Variable annuity contracts can be purchased either by making a single purchase payment or a series of purchase payments. Variable annuities offer a range of investment options, and the value of the variable annuities depend on the market performances of the selected investment options. Examples of these investment options can include mutual funds that invest in stocks, bonds, money market instruments, or a combination thereof.

Variable annuities charge a range of expenses, including Mortality and Expense (M&E) risk charges. The M&E risk charge is typically a certain percentage of the account value, and this percentage is typically the same for all holders of the variable annuity product. For example, the variable annuity may have an M&E risk charge with an annual rate of 1.25% of the account value. The M&E risk charge compensates the insurance company for insurance risks (e.g., early deaths for death benefits) it assumes under an annuity contract. The M&E charge may also include profit for the insurance company.

### SUMMARY

This summary is provided to introduce a selection of concepts in a simplified form that are further described below in the Detailed Description. This summary is not intended to identify key features or essential features of the claimed subject matter, and instead presents various illustrative aspects described herein.

The Mortality and Expense (M&E) risk charges described above reduce the market return/performance for the variable annuities. Accordingly, prospective annuity contract owners prefer to reduce the M&E risk charges associated with variable annuities.

According to aspects described herein, methods for providing an annuity product are described. The methods may involve an annuity contract between a first party that is a financial entity and a second party, wherein the annuity contract provides a plurality of ranges for premiums paid into the annuity contract, wherein each range is associated with one of a plurality of M&E rates. For instance, such a method may include determining, for a first premium payment through the second party paid into the annuity contract, an associated first premium range from the plurality of ranges and a first M&E rate from the plurality of M&E rates associated with the first premium range, and applying the first M&E percentage rate to at least a portion of the first premium payment.

Further aspects are directed to annuity products themselves. For instance, an annuity product may include an annuity contract calling for at least one premium payment to be paid into the annuity contract, and a separate account associated with the annuity contract, wherein at least a portion of the premium payment is allocated to the separate account and wherein an M&E rate applicable to the separate account is determined based upon an amount of the premium payment.

In addition, various aspects are directed to further methods for providing annuity products. For instance, such a method may include establishing an annuity contract that calls for a first premium payment, wherein at least a portion of the first premium payment is allocated into a separate account provided under the annuity contract, receiving the first premium payment, and determining a first M&E rate applicable to the separate account, wherein the first M&E rate is based upon an amount of the first premium payment.

Still further aspects provide additional methods for providing an annuity product. For instance, such a method may include providing an annuity contract from a financial entity to a prospective contract owner, wherein the contract provides a plurality of ranges for an aggregate premium payment, wherein each range is associated with one of a plurality of Mortality and Expense (M&E) rates, receiving, at the financial entity, a first premium payment from the prospective contract owner, wherein the first premium payment is paid into the contract, determining a first one of the ranges and a first one of the M&E rates associated with the first range based on the aggregate premium payment, wherein the aggregate premium payment includes at least the first premium payment, and determining a first M&E charge based on the first M&E rate and at least a portion of the first premium payment.

Yet further aspects are directed to software and/or data stored on one or more computer-readable media for implementing portions or entireties of the various methods and annuity products described herein. For instance, one or more computer-readable media may be provided that store computer-executable instructions. When executed by a computer, the computer-executable instructions may cause the computer to perform a method including receiving data indicating an amount of a first premium for an annuity product, and determining a first M&E rate of the annuity product based on the amount of the first premium.

These and other aspects of the disclosure will be apparent upon consideration of the following detailed description.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a functional block diagram of an illustrative system overview for providing annuity products, according to various aspects described herein.

FIG. 2 is a flow chart of an illustrative method for determining Mortality & Expense (M&E) percentage rates for subsequent premium payments, according to various aspects described herein.

FIG. 3 is a diagram of an illustrative environment that may be used to implement various aspects described herein.

### DETAILED DESCRIPTION

As will be appreciated by one of ordinary skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

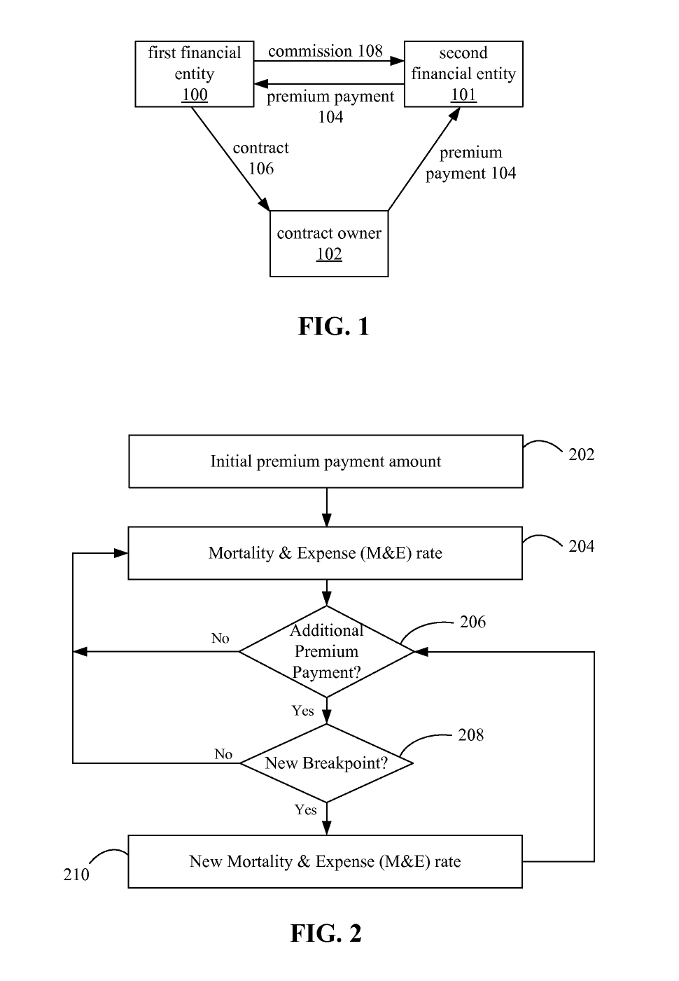

As will be described in connection with various examples, annuity products, including variable annuity products, may be provided. These annuity products may have Mortality and Expense (M&E) charge rates that vary across different breakpoints according to the size of the purchase payment and/or premium payment. FIG. 1 is a functional block diagram of an illustrative system overview for providing such annuity products. As shown in FIG. 1, the system includes a first financial entity 100, a second financial entity 101, and at least one prospective contract owner 102. The first financial entity 100 may be an insurance company or another entity (e.g., brokerage, bank, etc.) that issues one or more financial products (e.g., annuities and other investment options). The second financial entity 101 may be a broker/dealer having one or more NASD registered representatives that sells these financial products, including annuities and other investment instruments, to one or more prospective contract owners 102.

As shown in FIG. 1, a prospective contract owner 102 may purchase one or more annuity products issued by the first financial entity 100 (e.g., an insurance company) via the second financial entity 101 (e.g., a broker/dealer). More specifically, the prospective contract owner 102 may provide the second financial entity 101 with a premium payment 104, and the second financial entity 101 forwards the premium payment 104 to the first financial entity 100. The first financial entity 100 may then issue a contract 106 to the contract owner 102 for the purchased annuity product.

Still referring to FIG. 1, the second financial entity 101 (e.g., broker/dealer) may receive a commission 108 from the first financial entity 100 (e.g., an insurance company) for the contract owner's 102 purchase of the annuity product. This commission 108 may be based upon the amount of the premium payment 104, the value of the contract 106, or a combination thereof. For example, according to an exemplary embodiment of the present invention, the commissions 108 may generally decrease in percentage as the amount of the premium payment 104 increases. In addition, the commission 108 may include trail commission options. For example, an exemplary commission 108 may also include a 0.20%-0.30% trail commission for the second and subsequent years that the contract owner 102 continues the contract 106 with the first financial entity 100. This trail commission may be based upon the value of the contract 106.

Table I below illustrates an Option A and an Option B, as may be elected by the second financial entity 101, governing the amount of commissions 108 to be paid based upon the amount of premium payment 104. In particular, Table I illustrates breakpoints for the premium payment 104 amounts and corresponding percentage rates for the commissions 108. In addition, Option A does not include a trail commission option while Option B includes a 0.25% trail commission as described above. One of ordinary skill in the art will recognize that while specific percentages and breakpoints for premium payment 104 amounts are listed in Table I, those percentages and breakpoints are for illustrative purposes only and that other examples may utilize different percentages, breakpoints, and calculations for the commissions 108.

TABLE I

| Option A | Option B |
|---|---|
| $50,000–$99,999 = 5.00% | $50,000–$99,999 = 4.00% |
| $100,000–$249,999 = 4.00% | $100,000–$249,999 = 3.00% |
| $250,000–$499,999 = 3.25% | $250,000–$499,999 = 2.25% |
| $500,000–$749,999 = 2.85% | $500,000–$749,999 = 1.85% |
| $750,000–$999,999 = 2.45% | $750,000–$999,999 = 1.45% |
| $1,000,000+ = 2.25% | $1,000,000+ = 1.25% |

The contract 106 may be associated with a single premium deferred variable and fixed annuity contract, although other embodiments may only include one of a variable annuity and fixed annuity contract. In accordance with the contract 106, the contract owner 102 may allocate at least a portion of the premium payment 104 to one or more fixed accounts and/or one or more of the sub-accounts of a separate account under the contract 106 issued by the first financial entity 100. The fixed accounts may allow the contract owner 102 to allocate at least a portion of the premium payment 104 to an account that guarantees an interest rate (or return) for a specified period. As an example, the specified period for a particular fixed account may be 1, 3, 5, or 7 years. In contrast to the fixed account, the separate account may allow the contract owner 102 to allocate at least a portion of the premium payment 104 to one or more sub-accounts. These sub-accounts may invest in one or more mutual-funds whose value may vary depending on market performance. One of ordinary skill in the art will recognize that in other examples, the sub-accounts may also invest in or may be associated with one or more exchange traded funds (ETFs), stocks, hedge funds, unit investment trusts (UITs), closed-end funds, other investment pools, variable annuities, retirement savings vehicles (e.g., 401(K)s, 403(b)s, IRAs, etc.), educational savings plans (e.g., education savings accounts, 529 plans, etc.), and separately managed accounts (SMAs).

In accordance with the contract 106, the first financial entity 100 may assess periodic M&E charges on the contract's 106 net asset value allocated to the separate account. For example, the M&E charge may be assessed on a daily basis (e.g., as a percentage of a daily net asset value), although other time periods can be utilized. Moreover, the M&E charge may be calculated as a percentage of the contract's 106 daily net asset value allocated to the separate account, and this percentage rate may be based upon the premium payment 104 amount provided by the contract owner 102 at the time of issuance of the contract 106. In particular, the percentage rate for the M&E charge may vary, such as across several ranges or breakpoints, depending upon the initial premium payment 104 amount. Indeed, the M&E percentage rate may generally decrease across one or more ranges or breakpoints as the initial premium payment 104 amount increases. Once the M&E percentage rate has been determined, it may remain constant or else not be revised upwards for the life of the contract 106. This may remain true even if the contract 106 value changes due to market performance, withdrawals, or subsequent premium payment 104 amounts. Table II below shows examples of annualized M&E percentage rates based upon the initial premium payment 104 amounts. However, the breakpoints and M&E percentage rates in Table II may be defined as desired, and may be defined on a contract-by-contract basis or applied to a number of contracts.

TABLE II

| Breakpoints based upon premium | Annual Mortality & Expense |
|---|---|
| payment 104 amount | (M&E) Charge Percentage Rate |
| $50,000–$99,999 | 0.90% |
| $100,000–$249,999 | 0.60% |
| $250,000–$499,999 | 0.35% |
| $500,000–$749,999 | 0.25% |
| $750,000–$999,999 | 0.20% |
| $1,000,000+ | 0.15% |

The M&E percentage rates described above may in certain circumstances be revised down during the life of the contract 106. For example, referring to FIG. 2, the initial premium payment 104 amount (block 202) may result in a first M&E percentage rate (e.g., a maximum M&E percentage rate) according to a particular breakpoint, as shown in Table II (block 204). This M&E percentage rate may continue for the life of the contract 106 and continue to be associated with the initial premium payment 104 amount. For subsequent premiums 104 provided by the contract owner 102 (block 206), if the total of the previous premiums 104 and subsequent premiums 104 do not result in a breakpoint with a lower M&E percentage rate (block 208), then the previously-determined M&E percentage rate may still apply to the entire contract 106 value or the values of subsequent premiums 104. However, if the total of the previous premium payment 104 amounts and the subsequent premium payment 104 amounts results in a breakpoint with a lower M&E percentage rate than the previous M&E percentage rate (block 208), then the lower M&E percentage rate may apply to the subsequent premium payments 104, the value of the subsequent premium payments 104, or at least a portion thereof (block 210).

However, the lower M&E percentage rate may apply not only to the subsequent premium payment 104 amounts, but also to the previous premium payments 104, the value of the previous premium payments 104, or at least a portion thereof. The earnings on the premiums 104 may also have an associated M&E percentage rate that generally follows the M&E percentage rate on the corresponding premiums 104. In addition, the M&E percentage rate for the contract 106 may be automatically reduced after a predetermined amount of time, perhaps 7 to 8 years. These are merely examples, and the amount of time and/or the size of the reduction in M&E percentage rates may be set as desired.

The M&E percentage rate may further be determined based upon a statement of intention (also referred to as a letter of intent) or other indication of a commitment by which the contract owner 102 may commit to make a certain amount of premium payments 104 within a predetermined amount of time. For example, a statement of intention may commit to make a premium payment 104 of $500,000 within six months of the issuance of the contract 106. In accordance with the statement of intention, the committed amount of the premium payments 104 may be utilized to initially determine an M&E percentage rate for those premium payments 104 according to the breakpoint within which the committed amount (e.g., $500,000) falls. Thus, those premium payments 104 made during the time period indicated by the statement of intention may be subject to M&E percentage rate applicable for the entire committed amount.

However, the M&E percentage rate may be modified, perhaps at the end of the time period for the statement of intention, if the committed amount has not been met or if committed amount has been exceeded. If the committed amount has not been met, then the M&E percentage rate that was initially determined from the committed amount may be revised upwards in accordance with the actual amount of premium payments 104. For instance, the actual amount of premium payments 104 made within the time period for the statement of intention may be used to determine a new breakpoint, as illustrated by Table II above, which may result in a higher M&E percentage rate. On the other hand, if the committed amount has been exceeded, then the M&E percentage rate that was initially determined from the committed amount may be revised lower if the actual premiums payments 104 amounts fall within a breakpoint with a lower M&E percentage rate.

For a particular contract 106, the M&E percentage rate associated with a breakpoint may be determined according to an aggregate premium, which may include the amount of the premium payment 104 and the value of qualifying contracts. In particular, qualifying contracts may include other annuity contracts purchased by the contract owner 102 from the first financial entity 101, where the other annuity contracts are in the accumulation phase, and not in the payout phase. Thus, for a particular contract 106, an aggregate premium may be determined by including at least the initial premium payment 104 amount and the values of the qualifying contracts at the time of issuance of the contract 106. Accordingly, the M&E percentage rate may be determined based upon the breakpoint in which aggregate premium falls within. Many variations of the above-described embodiments for determining the M&E percentage rate are possible, including combining aspects of the above-described embodiments. For example, the above-described aggregate premium may additionally include the committed amount specified in the statement of intention.

In addition to the M&E charges, the first financial entity 100 may also assess a withdrawal charge or surrender charge on withdrawals of the premium payment 104 from the contract 106. This withdrawal or surrender charge may depend upon the time that has elapsed since the premium payment 104 was deposited into the contract 106. Moreover, the withdrawal or surrender charges may not apply to earnings associated with the premium payment 104. In other words, the earnings may be withdrawn free of the withdrawal or surrender charges. In addition, the withdrawal or surrender charges may apply on a first-in, first-out (FIFO) basis for the premium payments 104 according to an exemplary embodiment of the present invention. For example, Table III illustrates an exemplary set of surrender or withdrawal charges. It is noted that, the time periods and withdrawal or surrender charges shown in Table III may be readily modified as desired.

TABLE III

| | | | | | | | |
|---|---|---|---|---|---|---|---|
| Completed Years | 0 | 1 | 2 | 3 | 4 | 5 | 6+ |
| (since receipt of | | | | | | | |
| premium payment | | | | | | | |
| 104) | | | | | | | |
| Applicable Charge | 5% | 4% | 3% | 3% | 2% | 1% | 0% |
| (% of premium | | | | | | | |
| payment 104) | | | | | | | |

In addition to the M&E charges and surrender or withdrawal charges described above, other charges such as administrative charges may be assessed. The administrative charges may range from, for example, 15 to 35 basis points annually. Examples of other potential charges include transfer charges and annual contract 106 maintenance charges. Any or all of the charges described herein may be satisfied by direct redemptions or withdrawals by the first financial entity 100 from the value of the contract 106, including from the contract's 106 sub-accounts. In addition, direct redemptions or withdrawals may be made from the contract's 106 fixed accounts. Alternatively, the charges may be satisfied by external payments from the contract owner 102 to the first financial entity 100.

Optional benefits may be provided to the contract owner 102 under the terms of the contract 106. In particular, the optional benefits may include one or more of the three following benefits: death benefits, earnings protection benefits, and living benefits. One or more of these optional benefits may be required to be selected at the time of application for the contract 106, and an additional limitation may be imposed preventing cancellation of chosen optional benefits for the duration of the contract 106. Moreover, one or more of these optional benefits may be elected after issue of the contract 106. Each of these three optional benefits will now be illustratively described in the order presented above.

First, with respect to optional death benefits paid upon death of the contract owner 102, the contract 106 may provide for a return of premium death benefit or a highest anniversary value death benefit. In accordance with the return of premium death benefit, the amount paid to one or more beneficiaries of the contract 106 by the first financial entity 100 may be the greater of: (1) the value of the contract 106 and (2) the premiums 104 paid into the contract 106 less any withdrawals, including any applicable charges and adjustments for such withdrawals. Any withdrawals may reduce the amount in item (2) above in the same proportion that the contract 106 value was reduced on the date of such withdrawal.

Likewise, in accordance with the highest anniversary value death benefit, the amount paid to one or more beneficiaries of the contract 106 by the first financial entity 100 may be the greater of: (1) the value of the contract 106, (2) the premiums 104 paid into the contract 106 less any withdrawals, including any applicable charges and adjustments for such withdrawals, and (3) the greatest contract 106 value on any contract anniversary prior to the contract owner's 102 particular birthday, such as the 81st birthday, with several adjustments. These adjustments may include (i) deducting any withdrawals subsequent to the contract 106 anniversary (including any applicable charges and adjustments for such withdrawals), (ii) adding any premium 104 paid (net of any applicable premium 104 taxes) subsequent to the contract 106 anniversary, (iii) deducting any annual contract 106 maintenance charge, transfer charges, and any applicable charges due under any endorsement to the contract 106 deducted subsequent to the contract 106 anniversary, and (iv) deducting any taxes deducted subsequent to the contract 106 anniversary. The adjustments described above can be set as desired. In addition, any withdrawals may reduce the amount in items (2) and (3) above in the same proportion that the contract 106 value was reduced on the date of such withdrawal.

The illustrative death benefits described above, which may include the return of premium death benefit and the highest anniversary value death benefit, may have an associated periodic asset charge. This asset charge may be deducted periodically, such as daily, and may be considered an annual asset charge having a rate of, e.g., approximately 0.15% to 0.60% of the daily net asset value of the separate account. One of ordinary skill in the art will recognize that this asset charge and the other types of death benefit options may be defined as desired.

Second, the contract 106 may provide for an earnings protection benefit upon the death of the contract owner 102 in accordance with an embodiment of the present invention. For example, in accordance with the earnings protection benefit, an additional amount over and above the death benefit provided by the contract 106 may be paid by the first financial entity 100 to one or more beneficiaries of the contract 106. This earnings protection benefit may allow the beneficiaries to offset at least a portion of one or more taxes that may be levied on the death benefit receipt. Under the earnings protection benefit, a beneficiary may be paid a percentage of the contract 106 earnings, such as within a range of 25% to 40% of the contract 106 earnings, subject to a maximum percentage, such as about 225% to 275%, of the remaining premiums 104 in the contract 106. The earnings protection benefit may have an associated annual cost, such as about 0.25%-0.35%, (deducted periodically, such as daily) of the contract's 106 daily net asset value allocated to the separate account. In addition, there may be a charge on the fixed account. One of ordinary skill in the art will recognize that the costs associated with the earnings protection benefit may be set as desired.

Third, with respect to the living benefits, the contract 106 may provide for a guaranteed minimum withdrawal benefit (GMWB), which may be, for instance, a 5% GMWB. At the time of election of the GMWB, the guaranteed withdrawal benefit (GWB) may be equal to or otherwise based on the value of the contract 106. Alternatively, the GWB may be equal to or otherwise based on the premium payment 104 paid into the contract 106 or only the portion of the premium payment 104 allocated to the separate account. This GWB represents the minimum total amount that will be paid out under the GMWB. The guaranteed annual withdrawal amount (GAWA) may be based on the GWB, such as 5% of the GWB. The contract owner 102 thus may be allowed, under the benefit, to withdraw up to the GAWA each year from the contract 106, and any withdrawals made by the contract owner 102 would reduce the GWB accordingly. If the entire value of the contract 106 has been depleted and a GWB still remains, then the first financial entity 100 would make one or more direct payments to the contract owner 102 up to the GAWA each year until the GWB is depleted. In this way, the contract owner 102 is guaranteed to receive at least the GAWA each year up to the GWB. Once the GWB has been satisfied, the first financial entity 100 would have no further payment obligations to the contract owner 102. The cost associated with the GMWB may range from, for example, 0.30% to 1.00% annually of the GWB, and may be assessed periodically, such as quarterly. Alternatively, the GWB may be assessed as a percentage of the value of the contract 106 or the value of the contract's 106 separate account. One of ordinary skill in the art will recognize that these costs may be set as desired.

In addition, certain qualified plans may have required minimum distributions (RMDs) that may exceed the GAWA discussed above. In such instances, the benefit may provide for withdrawals up to the RMD amount without penalty. Accordingly, the GAWA may still remain the same, but the GWB may be reduced for the withdrawal, as discussed above.

The GMWB described above may alternatively be provided with a life guarantee (also referred to as a for-life GMWB, such as a 5% for life GMWB). The for-life GMWB may become effective once the contract owner 102 achieves a certain age, such as 65 years of age. Once the life guarantee becomes effective, the GAWA may be reset to a particular percentage (e.g., 5%) of the current GWB. The for-life GMWB may then terminate upon the death of the contract owner(s) 102. The costs associated with the for-life GMWB may be based, at least in part, upon the age of the contract owner(s) 102. For example, the cost associated with a 5% for life GMWB may range from 0.50% to 1.50% annually of the GWB, and may be assessed periodically, such as quarterly. Alternatively, the GWB may be assessed as a percentage of the value of the contract 106 or the value of the contract's 106 separate account. One of ordinary skill in the art will recognize that the life guarantee may also include a joint-and-survivor life guarantee, and that the costs associated with these life guarantees, including a single life or joint-and-survivor life guarantee, may be set as desired.

The GMWB or for-life GMWB as described above may be provided with a step-up provision. With the step-up provision, the current GWB and GAWA can be adjusted upwards periodically, such as annually for a certain number of years. For instance, the current GWB may be increased if the value of the contract 106 value has increased beyond the GWB. If the current GWB is stepped up, the new GAWA may be calculated as a portion or percentage of the new GWB, such as 5%. The new GWB or GAWA may be set or adjusted such that it is not lower than the previously-determined GWB and GAWA.

In addition, the GMWB or for-life GMWB may be further provided with a bonus provision, where the bonus provision may be effective for a particular period of time. For example, the bonus provision may be effective for the first 10 years of the contract 106 or until the contract owner 102 reaches a particular age, such as age 81. Under the bonus provision, if the contract owner 102 is eligible to make a withdrawal under the optional GMWB, but declines to do so, then the GWB may be increased by a calculated amount. This increased amount may be calculated as a percentage, such as 5%, of a bonus base. The bonus base may equal the GWB at the time of election of the GMWB. However, this bonus base may be adjusted based upon the step-up provision described above or for certain withdrawals. This increase in the GWB may also result in an increase in the GAWA.

The optional benefits described above, including the death benefits, earnings protection benefits, and/or living benefits may terminate if the contract owner 102 elects to annuitize the value of the contract 106. In particular, the contract owner 102 may select one or more annuity income options, including a life income, a joint and survivor annuity, a life annuity with a certain number of guaranteed periods (e.g., 120 months, 240 months, etc.), income for a specified period, and/or other annuities as known to one of ordinary skill in the art. In addition, the contract owner 102 may choose between fixed and variable annuity payment options. With fixed annuity payments, the amount of each fixed annuity payment may be determined by applying the portion of the contract 106 value allocated to the fixed annuity payments, less any fees and charges such as taxes, to an annuity table applicable to the selected income option. With variable annuity payments, the amount of each payment may vary based upon on market performance of the underlying investments.

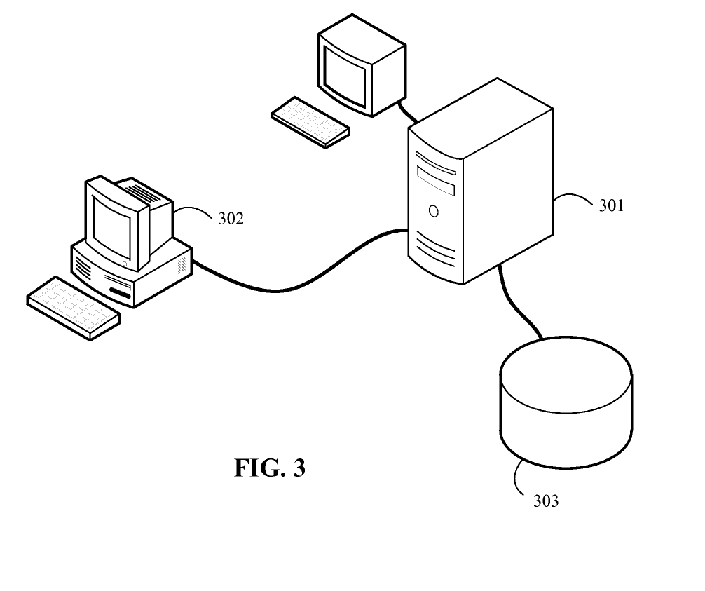

The above-described features of an annuity may be tracked, calculated, and otherwise implemented using one or more computers. For instance, referring to FIG. 3, a server 301 and associated terminal may be coupled to a personal computer 302 via a signal connection. The server 301 and/or the personal computer 302 may further be coupled to a storage unit 303 having one or more computer-readable media (such as a hard disk drive). The storage unit 303 which may be physically separate from or integrated with the server 301 and/or the personal computer 302. The server 301, the personal computer 302, and/or the storage unit 303 may be located at, used by, and/or under the control of, the first financial entity 100 and/or the second financial entity 101.

The server 301 and/or the personal computer 302 may execute software, in the form of computer-executable instructions. The software may be stored on, for example, the computer-readable media of the storage unit 303. The storage unit 303 may also store various data such as a table of breakpoint ranges versus M&E rates. When executed, the software may cause the server 301 and/or the personal computer 302 to keep track of the assets, fees (e.g., M&E rates), and other properties of each annuity. For example, for a given annuity, the software may cause the server 301 and/or the personal computer 302 to receive data representing one or more premiums paid (or to be paid), refer to the M&E breakpoint range table, and automatically determine the M&E charges in any of the various methods described herein.

The shown set of computers in FIG. 3 is merely illustrative; any number and type of computers may be used. In the shown example, the server 301 may perform the M&E and other determinations and the personal computer 302 may be used to view and interact with those determinations. Or, the server 301 may merely provide the relevant data to the personal computer 302 and the personal computer 302 may perform the determinations. In either case, the connection between the server 301 and the personal computer 302 may be a direct connection such as a cable or a network such as a local area network and/or the Internet. Where the connection is a network, the server 301 and the personal computer 302 may be at geographically different locations, even in different countries.

Various modifications and other examples may come to mind to one skilled in the art to the described aspects, having the benefit of the teachings presented in the foregoing descriptions and the associated drawings. Therefore, it is to be understood that the aspects described herein are not to be limited to the specific examples disclosed.

What is claimed is:

1. A method for providing an annuity product involving an annuity contract between a first party that is a financial entity and a second party, wherein the annuity contract provides a plurality of ranges for premiums paid into the annuity contract, wherein each range is associated with one of a plurality of Mortality and Expense (M&E) rates, the method comprising:
determining, for a first premium payment through the second party paid into the annuity contract, an associated first premium range from the plurality of ranges and a first M&E rate from the plurality of M&E rates associated with the first premium range; and
applying the first M&E percentage rate to at least a portion of the first premium payment.

2. The method of claim 1, wherein the annuity contract further provides a surrender charge for withdrawal of a premium paid into the annuity contract, wherein the method includes applying the surrender charge responsive to the withdrawal of the premium being made within a predetermined period from a date that the withdrawn premium was paid into the annuity contract.

3. The method of claim 1, further including allocating at least a portion of the first premium payment to a separate account associated with the annuity contract.

4. The method of claim 3, further including applying the first M&E rate to the portion of the first premium payment allocated to the separate account.

5. The method of claim 1, further including allocating at least a portion of the first premium payment to one or more fixed accounts.

6. The method of claim 5, further comprising:
determining a second premium range from the plurality of ranges and a second M&E rate from the plurality of M&E rates associated with the second premium range, both based upon a total of the first premium payment and a later second premium payment into the annuity contract; and
applying the second M&E rate to at least a portion of the second premium payment.

7. The method of claim 6, further including adjusting the first M&E rate to the second M&E rate.

8. The method of claim 1, further comprising providing an option of selecting at least one of a death benefit, an earnings protection benefit, or a living benefit, associated with at least a portion of the first premium payment.

9. An annuity product, comprising:
an annuity contract calling for at least one premium payment to be paid into the annuity contract; and
a separate account associated with the annuity contract, wherein at least a portion of the premium payment is allocated to the separate account and wherein a Mortality and Expense (M&E) rate applicable to the separate account is determined based upon an amount of the premium payment.

10. The annuity product of claim 9, wherein the annuity contract associates a plurality of breakpoint ranges with a plurality of M&E rates and wherein one of the plurality of M&E rates applicable to the separate account is determined based on a comparison of the breakpoint ranges with the amount of the premium payment.

11. The annuity product of claim 9, wherein the contract further calls for surrender charges for withdrawal of at least a portion of the premium payment paid into the annuity contract, wherein the withdrawal is made within a certain period from the date the premium payment was paid into the contract.

12. The annuity product of claim 9, further including a fixed account, wherein at least a portion of the premium payment is allocated to the fixed account.

13. The annuity product of claim 9, wherein an M&E charge for the separate account is determined by applying the M&E rate to the value of the separate account.

14. The annuity product of claim 9, wherein an M&E charge for the separate account is determined by applying the M&E rate to the value of the annuity contract.

15. A method for providing annuity products, comprising:
establishing an annuity contract that calls for a first premium payment, wherein at least a portion of the first premium payment is allocated into a separate account provided under the annuity contract;
receiving the first premium payment; and
determining a first Mortality and Expense (M&E) rate, wherein the first M&E rate is based upon an amount of the first premium payment.

16. The method of claim 15, wherein determining the first M&E rate includes determining which range out of a plurality of ranges is associated with the amount of first premium payment, wherein each of the ranges is further associated with a different M&E rate.

17. The method of claim 16, further including:
receiving a second premium payment subsequent to the first premium payment; and
determining a second M&E rate based on a total of the first and second premium payments.

18. The method of claim 17, wherein determining the second M&E rate includes determining the second M&E rate to be a rate lower than the first M&E rate if the total of the first premium payment and the second premium payment is within one of the ranges associated with an M&E rate lower than the first M&E rate.

19. The method of claim 17, wherein the first and second M&E rates are each maximum M&E rates.

20. The method of claim 15, further including:
receiving a second premium payment subsequent to the first premium payment;
determining a second M&E rate based on the second premium payment but not the first premium payment;
applying the first M&E rate to a value of the first premium payment; and
applying the second M&E rate to a value of the second premium payment.

21. A method for providing an annuity product, comprising:
providing an annuity contract from a financial entity to a prospective contract owner, wherein the contract provides a plurality of ranges for an aggregate premium payment, wherein each range is associated with one of a plurality of Mortality and Expense (M&E) rates;
receiving, at the financial entity, a first premium payment from the prospective contract owner, wherein the first premium payment is paid into the contract;
determining a first one of the ranges and a first one of the M&E rates associated with the first range based on the aggregate premium payment, wherein the aggregate premium payment includes at least the first premium payment; and
determining a first M&E charge based on the first M&E rate and at least a portion of the first premium payment.

22. The method of claim 21, wherein the aggregate premium payment further includes a committed amount specified in a statement of intention, the method further including increasing the first M&E rate in response to the committed amount in the statement of intention having not been satisfied.

23. One or more computer-readable media storing computer-executable instructions, that, when executed by a computer, cause the computer to perform a method comprising:
receiving data indicating an amount of a first premium for an annuity product; and
determining a first M&E rate of the annuity product based on the amount of the first premium.

24. The one or more computer-readable media of claim 23, wherein determining the first M&E rate includes:
comparing the amount of the first premium with a plurality of ranges of amounts to determine which of the ranges includes the amount of the first premium, each of the ranges having an associated M&E rate; and
determining the first M&E rate to be the M&E rate associated with the determined range.

25. The one or more computer-readable media of claim 23, wherein the method further includes:
receiving data indicating an amount of a second premium for the annuity product; and
determining a second M&E rate of the annuity product based on the amount of the second premium.

26. The one or more computer-readable media of claim 25, wherein determining the second M&E rate includes determining the second M&E rate based on a total of the amounts of the first and second premiums.
